(19) United States
(12) Patent Application Publication
(10) Pub. No.: US 2008/0300035 A1
(43) Pub. Date: Dec. 4, 2008

(54) Clear Path Electronic Game

(75) Inventors: John Mitchell Cutter, Sammamish, WA (US); Tabitha L. Holmquist, Seattle, WA (US)

Correspondence Address: LEE & HAYES, PLLC, 421 W. RIVERSIDE AVE, STE 500, SPOKANE, WA, 99201, US

(73) Assignee: BIG FISH GAMES, INC., Seattle, WA (US)

(21) Appl. No.: 11/756,589

(22) Filed: May 31, 2007

(51) Int. Cl. G06F 17/00

(52) U.S. Cl. 463/14

(57) ABSTRACT

A clear path electronic game is described in which one or more vessels are placed adjacent a mines of various sizes on rows of a grid. The game player then activates one mine at a maximum size to shoot a projectile at another mine. The mine shooting the projectile is removed. When the projectile hits the mine, the mine either grows or is removed from the grid. In response to the mine on the row adjacent one of the vessels being removed, the vessel is moved in its row across the former location of the removed mine. The vessel continues to move in the row off of the grid unless there is another mine in the row. Points are awarded for removing vessels and mines. Play ends when all maximum size mines are removed and when there are not vessels of the first type that has been removed from the grid.

### BACKGROUND

Currently, video games, such as “Splash Back” have objects that are placed in rows and columns in a video game window. The objects have different sizes and expand when supplied with virtual water droplets. A maximum size object, when supplied with a water droplet, explodes into four directions (both horizontally and vertically) spewing additional water droplets. When these droplets contact another maximum size object, the object also explodes spewing water. Thus when one maximum size object explodes, it may set off a virtual chain reaction.

The objective of the game is to eliminate all the objects in the rows and columns before the game player runs out of a predetermined number of water droplets. After eliminating the objects, the level of complexity is increased by providing a larger number of small sized objects.

In these games the score is based on the level the game player reaches. Further only the objects expand, and there is neither movement of objects in the game nor a collection of bonus items that affect the score.

### SUMMARY

A computer game system is described in which a vessel is placed adjacent a first mine on a grid in a first row. The game player then selects the first mine that shoots a projectile at a second mine. Upon shooting the projectile, the first mine is removed. In response to the first mine being removed, the first vessel is moved in the first row across the former location of the first removed mine.

A score is then provided that corresponds to: an amount of bonus items found, the level that the game player reaches, the number of mines cleared before the vessels are lost and a bonus for the removal of all of the mines.

This summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIGS. 1A-1D are a depiction of a sequence of screen shots illustrating the playing of the clear path electronic game.

FIGS. 2A and 2B are a depiction of another sequence of screen shots illustrating another embodiment of playing the clear path electronic game.

FIG. 3 is a depiction of an electronic device used for playing the clear path electronic game.

FIGS. 4A-D are a depiction of flowcharts for implementing the clear path electronic game.

### DETAILED DESCRIPTION

The following document describes method(s) or software capable of instantiating a computer video game. The video game may be executed on any electronic device such as a computer, PDA, computer laptop or gaming device. The computer game software is operable to enable a game player to explode mines to clear a path to move a vessel off of a grid.

The construction of the video game and an environment in which this video game may be enabled by techniques is set forth first below. This is followed by others sections describing various inventive techniques and illustrative embodiments of other aspects of the video game.

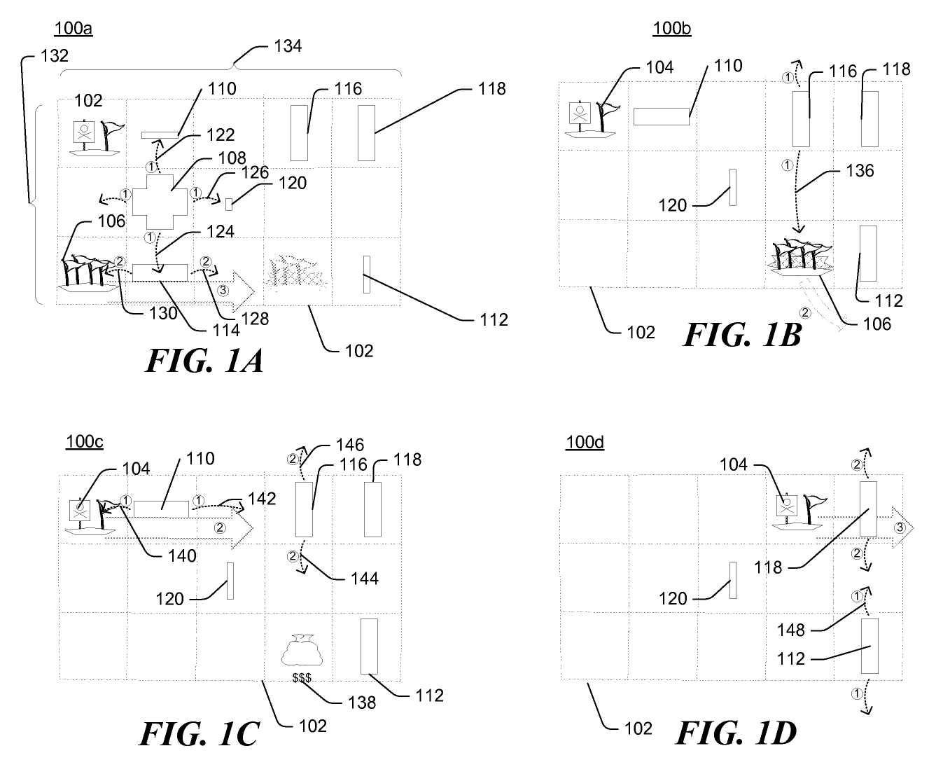

Illustrated in FIGS. 1A-1D are exemplary displays 100(a-d) of a sequence of four scenes, respectively, that a game player may encounter when playing the clear path game. The display 100a shows a plurality of gaming objects 104-120 arranged on a two-dimensional grid 102. The grid 102 is arranged in rows 132 and columns 134. The gaming objects 104, 110, 116 and 118 are positioned within a single row of the grid 102. Likewise gaming objects 106, 114, and 112 are positioned within a single row of the grid 102.

In one embodiment, the gaming objects 104 and 106 consist of two types of vessels. The vessels may be any type of object, including, but not limited to, vehicles, trains, plains, animals, vegetables, or minerals. In one embodiment, the first vessel type, such as a pirate ship 104, may be armed or unarmed. The second vessel type, such as a frigate 106, may be a nominal frigate 106 or a navy frigate (not shown in figure). Obstacles may include, for example, mines 108-120 or may include any object that disappears and launches a projectile. The mines 108-120 may have various sizes. Examples of the mines include small mines 120, medium mines 110, 112, and large mines 108, 114, 116, 118. In addition, the mines may have various orientations and launch the projectiles in varies directions. For example, multi-directional mines 108 launch projectiles horizontally and vertically, and single directional mines 110-120 launch projectiles horizontally or vertically.

The game commences by positioning one or more of a first type of vessel, such as pirate ships 104, adjacent to the obstacles, such as mines 110, 116 and 118 on the same row 132 of the grid 102. Further a second vessel type, such as a frigate, is placed on the same row as mine 112 and 114. During game play, the game player selects a large mine, resulting in the mine exploding and discharging projectiles in the direction of its orientation.

The discharged propellant travels horizontally and/or vertically on the grid until it impacts another gaming object. When the discharged propellant impacts a second large mine, the mine explodes and launches more propellants in the direction of the second mines orientation. Subsequent to the explosion, the mine is removed from the grid. In response to the mine being removed, the vessel in the same row adjacent to the mine moves horizontally to a position as far right as possible without overtaking another gaming object. When there are no longer any gaming objects to the right in the same row as the vessel, the vessel moves off of the grid. Once the vessel moves off of the grid, it automatically becomes part of the next level of the game. Any vessel that remains on the grid when all of the large mines are exploded becomes trapped and does not become part of subsequent game levels.

When discharged propellant impacts a smaller mine, the smaller mine grows larger. When launched propellant impacts a vessel for the first time, such as a frigate, the vessel becomes animated. In one embodiment, a frigate must be struck twice to be sunk. Once the frigate sinks, it is replaced on the grid 102 with a reward indication, such as a treasure 132. The game player then may score points and acquire a bonus objects by selecting the reward.

Referring to FIG. 1A, in one example, game play is first commenced with the game player selecting the multi-directional mine 108. The multi-directional mine 108 explodes upon selection, discharging propellants in four directions. Upon exploding, the multi-directional mine 108 is removed from the grid 102. Propellant 122, discharged from multi-directional mine 108, impacts the medium mine 110 and propellant 126 impacts small mine 120, resulting in the mines growing into a larger mines 110 and mine 120 (See FIG. 1B). Simultaneously, discharged propellant 124 impacts the larger mine 114 resulting in it exploding. Upon exploding, mine 114 is removed from the grid 102.

Second, large mine 114 explodes discharging propellant 128 and propellant 130. Discharged propellant 130 impacts the frigate 106 transforming it into an animated frigate 106 (See FIG. 1B). In one example frigate is animated by indicting that it is on fire. Simultaneously, discharged propellant 128 impacts a medium mine 112, resulting in it growing into a larger mine. Third, the animated frigate 106 moves to the right until it abuts large mine 112 (See FIG. 1B).

Referring to FIG. 1B, the game player first selects the large mine 116 to launch propellant 136 resulting in propellant striking the animated frigate 106. In one embodiment, this second impact to the animated frigate 106 results in the animated frigate 106 sinking and become replaced with the treasure 138 or a treasure chest (See FIG. 1C).

Referring to FIG. 1C, the game player first selects large mine 110, resulting in large mine 110 exploding. Upon exploding, large mine is removed from the grid 102 and discharges propellants 140 and 142 in a horizontal direction. Discharged propellant 140 impacts the pirate ship 104 and large mine 116, resulting in large mine 116 exploding. Propellant has no effect on pirate ship 104. Upon exploding, large mine 116 launches propellants 144, 146 vertically and is removed from the grid 102. Second, the pirate ship 104 moves horizontally to the right until it abuts large mine 118. Finally the game player may select the treasure 138 to be awarded bonus points or bonus objects, such a token. If the treasure 138 is impacted by propellant, it also becomes animated. Two propellant strikes on the treasure 138 cause it to be destroyed.

Referring to FIG. 1D, the game player first selects large mine 112, resulting in large mine 112 exploding and launching propellant 148 into large mine 118. Upon exploding, large mine 112 is removed from the grid 102. Second, when discharged propellant 148 impacts large mine 118, resulting in large mine 118 exploding and likewise being removed from the grid 102. Third, as the path is clear of any objects to the right of pirate ship 104, ship 104 automatically moves to the right off of the grid. The game play ends when there are no longer any large mines remaining on the grid 102 and if the game player has not rescued any pirate ships by getting them off of the right side of the gird. When game play ends, the remaining vessels on the grid of the first type are captured. The level ends if vessels of the first type, e.g. pirate ships, were saved and there are no large mines remaining on the grid. When the level ends, the game displays a score and the subsequent level automatically begins.

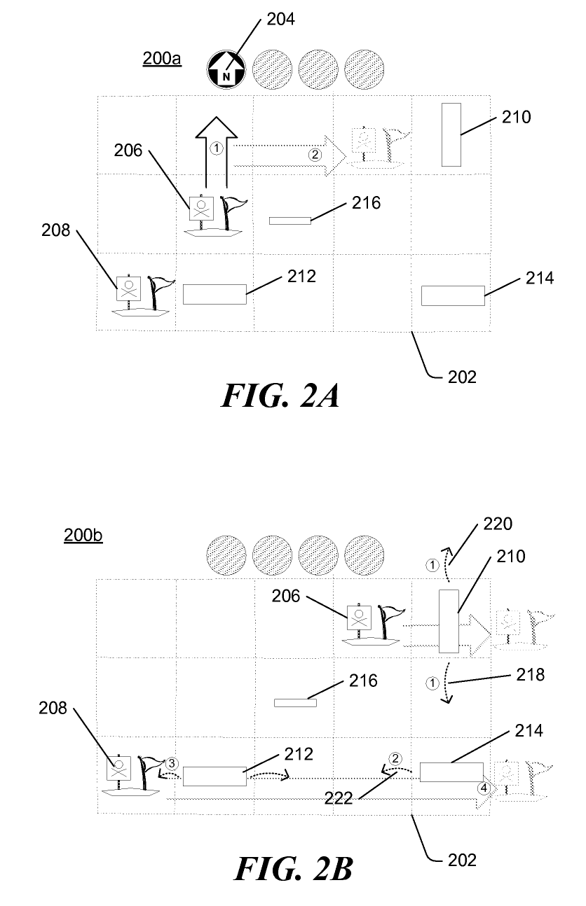

Illustrated in FIGS. 2A-2D are exemplary displays 200a and 200b of a sequence of two scenes, respectively, of another embodiment that a game player may encounter when playing the clear path video game. In this embodiment, the gaming objects 206-216 comprise the first type of vessels (e.g. pirate ships 206 and 208); various obstacles such as mines 210-216; and a bonus object. Various types of bonus objects, such as tokens and power-up object 204 are awarded in response to selecting the treasure 138. Power-up object 204 when selected can move an object in one of four directions. In one embodiment, the number of Power-up objects that can be acquired is limited to a maximum number. In this example, up to four Power-up objects can be acquired, and the Power-up object 202, when selected, can be used to move any object in a row north (e.g. vertically). There are six types of power-up objects, four types that can move any game object up, down, left or right respectively. There is another power-up object that will detonate any mine (even small and medium mines), and another power-up object the when selected results in vertical and horizontal mines rotating 90 degrees.

Referring to FIG. 2A, the game player selects the power-up object 204 and then selects the pirate ship 206. Selecting power-up object 204 and ship 206 results in the pirate ship 206 moving vertically (or north) one row while remaining in the same column. Second, the pirate ship 206 then automatically moves to the right until it reaches a position on the grid 202 adjacent to the mine 210. Once used, the power-up object 204 is removed from the game display 200a.

Referring to FIG. 2B, the example game continues with the game player first selecting large mine 210 resulting in large mine 210 exploding and launching propellant 218 and propellant 220. Upon exploding, mine 210 is removed from display, and the pirate ship 206 is moved to the right off of the grid 202.

Second, launched propellant 218 moves vertically and impacts large mine 214 resulting in large mine 214 exploding. Upon exploding, propellant 222 is launched, and large mine 214 is removed from the grid 202. Third, launched propellant 222 impacts large mine 212 resulting in large mine 212 exploding. Upon exploding, large mine 212 launches propellant and is removed. Further as the pirate ship 208 now has a clear path, it moves to the right off of the grid 202.

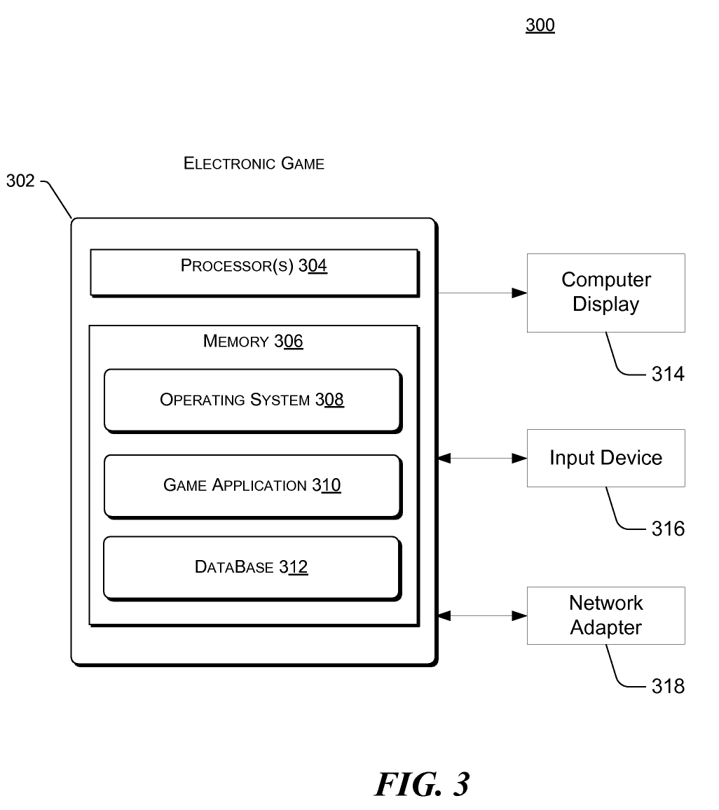

The computer environment 300 illustrated in FIG. 3 is a general computer environment that includes a user interface which can provide a computer video game to a game player. Similar resources may use the computer environment and the processes as described herein. The computer environment 300 is only one example of a computer environment and is not intended to suggest any limitation as to the scope of use or functionality of the computer and network architectures. Neither should the computer environment 300 be interpreted as having any dependency or requirement relating to any one or combination of components illustrated in the exemplary computer environment 300.

The computer environment 300 includes a general-purpose computing device in the form of a computer 302. The computer 302 can be, for example, one or more of a stand alone computer, laptop computer, a networked computer, a mainframe computer, a PDA, a telephone, a microcomputer or microprocessor, or any other computer device that uses a processor in combination with a memory. The components of the computer 304 can include, but are not limited to, one or more processors or processing units 302, a system memory 304, and a system bus (not shown) that couples various system components including the processor 302 and the system memory 304.

The computer 302 can comprise a variety of computer readable media. Such media may be any available media that is accessible by the computer 302 and includes both volatile and non-volatile media, and removable and non-removable media. The process for creating and playing the video game can be stored as instructions sets on the computer readable media.

The system memory 306 may include the computer readable media in the form of non-volatile memory such as read only memory (ROM) and/or volatile memory such as random access memory (RAM).

The computer 302 may also include other removable/non-removable, volatile/non-volatile computer storage media. By way of example, memory 306 may include a hard disk drive (not shown) for reading from and writing to a non-removable, non-volatile magnetic media (not shown), and an optical disk drive, for reading from and/or writing to a removable, non-volatile optical disk such as a CD-ROM, DVD-ROM, or other optical media. The hard disk drive and optical disk drive may each be directly or indirectly connected to the system bus.

The disk drives and their associated computer-readable media provide non-volatile storage of computer readable instructions, program modules, and other data for the computer 302. Although the example depicts a hard disk within the hard disk drive, it is to be appreciated that other types of the computer readable media which can maintain for accessing data that is accessible by a computer, such as non-volatile optical disk drives, floppy drives, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computer environment 300.

Memory 306 may be a magnetic disk non-volatile optical disk, ROM and/or RAM. Stored in memory 306, including by way of example, may be an operating system (OS) 308, one or more video game applications 310, and database 312.

A player can enter commands and information into the computer 302 via input devices 316 such as a keyboard and/or a pointing device (e.g., a “mouse”) which send a signal to the computer 302 in response to commands from the game player. Other input devices (not shown specifically) may include a microphone, joystick, game pad, satellite dish, serial port, scanner, and/or the like. These and other input devices are connected to the processing unit 304 via input/output interfaces (not shown) that are coupled to the system bus of computer 302, but may be connected by other interface and bus structures, such as a parallel port, game port, or a universal serial bus (USB).

A monitor, flat panel display, or other type of computer display 314 can also be connected to the system bus via a video interface (not shown), such as a video adapter. In addition to the computer display 314, other output peripheral devices can include components such as speakers (not shown) which can be connected to the computer 302.

The computer 302 can operate in a networked environment using logical connections to one or more remote computers, such as a remote computer device through network adapter 318. By way of example, the remote computer device can be a personal computer, portable computer, a server, a router, a network computer, a peer device or other common network node, game console, and the like. The remote computer device can be a server that can include many or all of the elements and features described herein relative to the computer 302.

Logical connections between the computer 302 and the remote computer device (e.g. a service provider) are depicted as an Internet (or Intranet) which may include a local area network (LAN) and/or a general wide area network (WAN). Video game application 310 may be initially stored on the server and be downloaded from the internet onto memory 306 in computer 302. Computer 302 may communicate to the remote computer device using any communications media.

Various modules and techniques may be described herein in the general context of the computer-executable instructions, such as program modules, executed by one or more computers or other devices. Generally, program modules include routines, programs, control objects, components, control node data structures, etc. that perform particular tasks or implement particular abstract data types. Often, the functionality of the program modules may be combined or distributed as desired in various embodiments.

Operating system 308 manages the interaction between the various applications, modules and tools in memory 306 and devices 314-318. Operating system 308 may a window operating system available from Microsoft Corp. of Redmond, Wash. or may include a middleware interfaces such as Flash by Adobe Inc. of San Jose, Calif. or Java by Sun Inc. of Santa Clara, Calif. Game application 310 may communicate with the operating system directly or via the middleware interface. The score of the game player of the level reached by the player may be stored in database 312.

Various modules and techniques may be described herein in the general context of the computer-executable instructions, such as program modules, executed by one or more computers or other devices. Generally, program modules include routines, programs, control objects, components, control node data structures, etc. that perform particular tasks or implement particular abstract data types. Often, the functionality of the program modules may be combined or distributed as desired in various embodiments.

An implementation of the aforementioned computer video game may be stored on some form of the computer readable media (such as optical disk) or transmitted from the computer media via a communications media to a game player computer. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any process or technology for storage of information such as computer readable instructions, control node data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### Exemplary Process

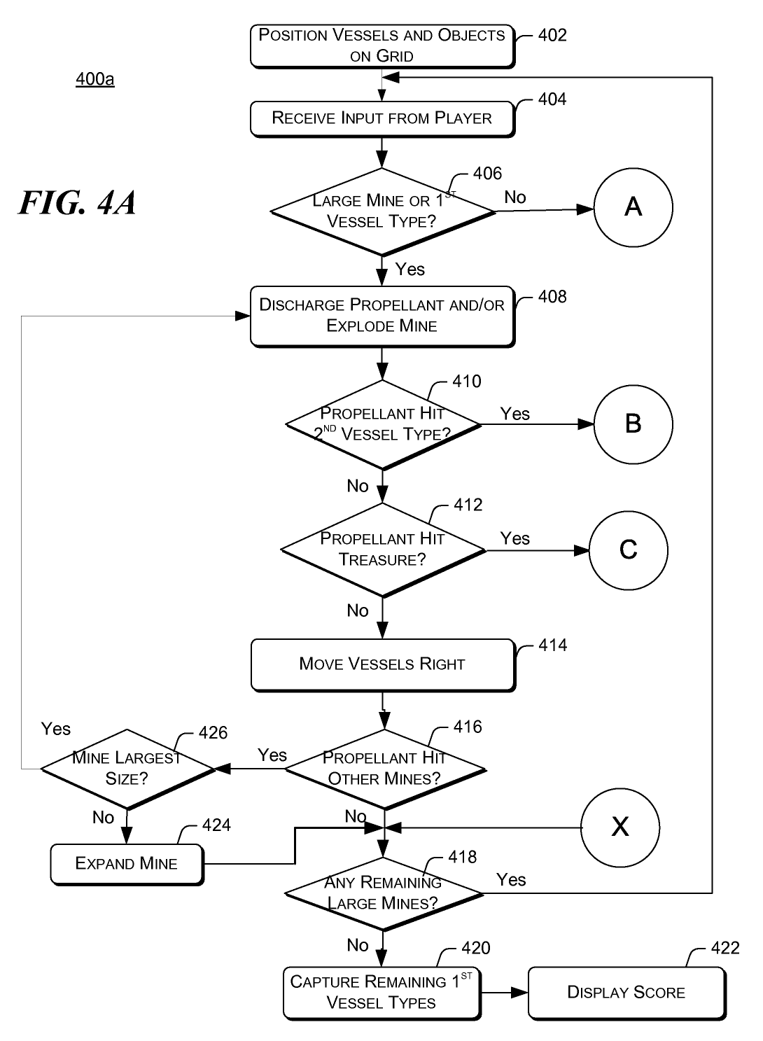

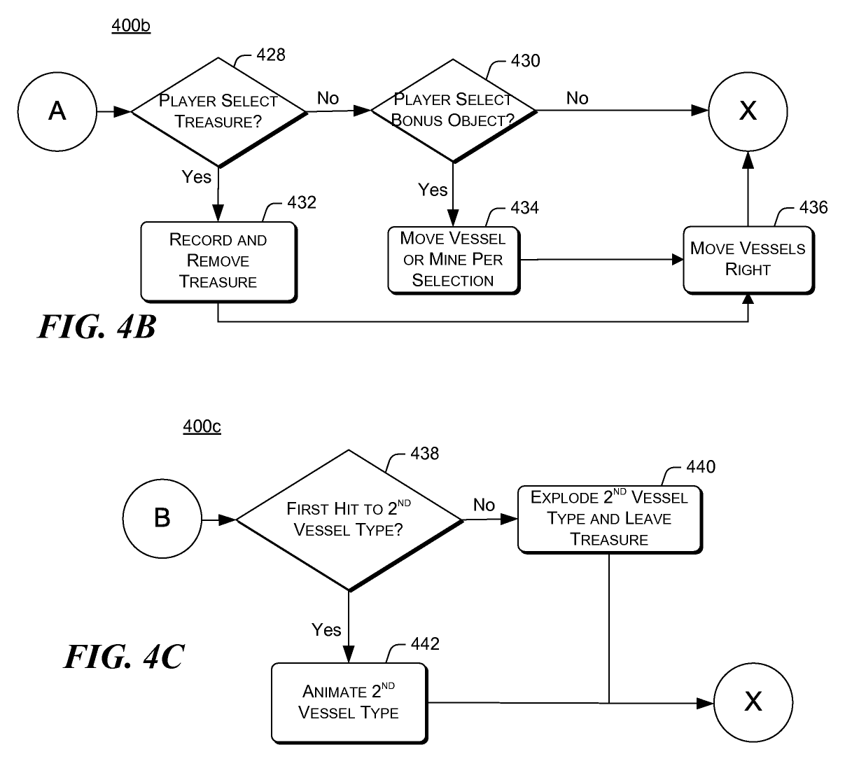

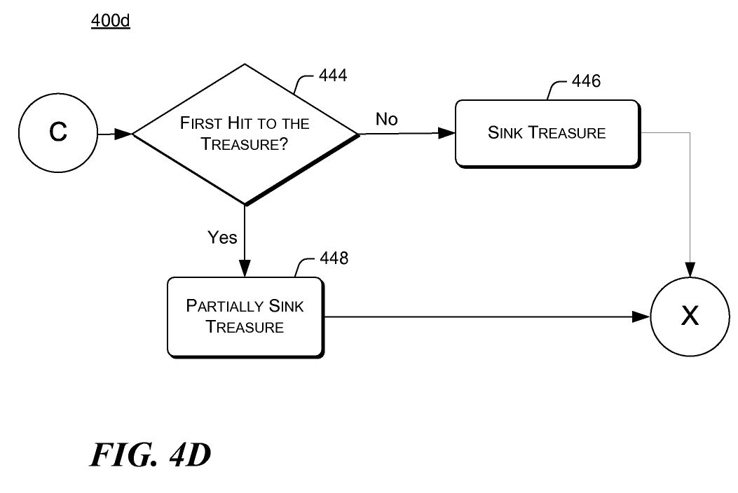

The exemplary processes, shown in FIGS. 4A-4D, are illustrated as a collection of blocks in a logical flow diagram. The flow diagram depicts exemplary processes 400a-d used by processor 304 (see FIG. 3) in system 300 (see FIG. 3), to play the clear path electronic video game and represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to system 300 of FIG. 3, although it may be implemented in other system architectures.

The clear path electronic video game is launched in block 402. When launched, objects and vessels are placed in a random order on the gaming display.

In block 404, the game player selects one of objects on the gaming display using the input device 316. A determination is made in block 406 as to whether the game player selected a large mine or the first vessel type. If the player did not select a large mine or the first vessel type (“no” to block 406), a determination is made in whether the player selected a treasure in block 428 (FIG. 4B).

If the game player selected either a large mine or a first type vessel (“yes” to block 406), then the game launches the propellant from the exploded mine in block 408 or if a vessel was selected that contained a propellant, then the propellant is launched from the vessel. In blocks 410, a determination is made whether the propellant hit a second vessel type. If the propellant hit the second vessel type (“yes” to block 410), then a determination is made, in block 438 (FIG. 4C), as to whether the hit was a first hit of the second vessel type. If the propellant did not hit the 2^{nd} vessel type (“no” to block 410), then in block 412, a determination is made at to whether the propellant hit a treasure.

If the propellant hit a treasure (“yes” to block 412), then a determination is made whether this hit to the treasure was enough to sink or partially sink the treasure in block 444 (FIG. 4D). If the propellant did not hit the treasure (“no” to block 412), the vessel adjacent to and in the same row as the exploded mine is moved horizontally to the right in block 414. If there are no more objects in the path of the vessel, then the vessel is moved off of the display. If there are objects in the same row as the vessel, then the vessel is placed adjacent to the object.

In block 416, a determination is made whether the propellant hit other mines. If the propellant hit another mine (“yes” to block 416) then a determination is made in block 426 whether the mine is the largest size. If the mine is the largest size (“yes” block 426) then the mine is exploded and launches a propellant in block 408. If the mine is not the largest size (“no” to block 426), then the mine is expanded in block 424.

In block 418, a determination is made whether there are any remaining large mines. If there are large mines remaining (“yes” to block 418) then the game player selects one of objects on the gaming display in block 404. If there are no more mines remaining (“no” to block 418) then the remaining first type of vessels are captured in block 420 and the score is displayed in block 422.

Referring to FIG. 4B, if the game player selected a treasure (“yes” to block 428), then the treasure is removed from play and the game player receives credit for selecting the treasure in block 432. If the game player did not select the treasure (“no” to block 428), then a determination is made whether the player selected a bonus object in block 430. If the game player selected a bonus object, such as a token (“yes” to block 430), then the game player is prompted to select a gaming object, such as a mine or a vessel to move the direction specified by the bonus object. In block 436, the vessel is moved horizontally to the right until it abuts an object, a vessel, or is moved off of the grid. The game then determines if there are any remaining large mines in block 418 (FIG. 4A).

Referring to FIG. 4C, a determination is made whether the hit on second vessel type was the first hit in block 438. If the hit was not the first hit of the second vessel type but was a hit sufficient to sink the second vessel type, e.g. the second hit (“no” to block 438), then the second vessel type is exploded and replaced with a treasure in block 440. If the hit was not enough to sink the second vessel type (“no” to block 438), then the second vessel type is animated. The game then determines if there are any remaining large mines in block 418 (FIG. 4A).

Referring to FIG. 4D, a determination is made whether the hit to the treasure was enough to sink or partially sink the treasure in block 444. If the hit was enough to sink the treasure (“yes’ to block 444), then the treasure sinks and is removed from the grid 202 in block 446. If the hit was not enough to sink the treasure (“no” to block 444), then an indication that the treasure is partially sunk is provided in block 448. The game then determines if there are any remaining large mines in block 418 (FIG. 4A).

### CONCLUSION

Above is described an apparatus and method for insertion of user selected graphics into a computer implemented video game. These and other techniques described herein may provide significant improvements over the current state of the art, to enable a non-technical individual to create and provide their own hidden objects game. Although the system and method has been described in language specific to structural features and/or methodological acts, it is to be understood that the system and method defined in the appended claims is not necessarily limited to the specific features or acts described. Rather, the specific features and acts are disclosed as illustrative forms of implementing the claimed system and method.

1. A computer-implemented method for playing an electronic video game, the method comprising:
placing a vessel and an adjacent a first mine on a grid in a first row;
selecting the first mine;
in response to the first mine being selected, shooting a projectile from the first mine at a second mine and removing the first mine; and
in response to the first mine being removed, moving the first vessel in the first row across the former location of the first removed mine.

2. The method as recited in claim 1 wherein said second mine has an initial size; wherein the second mine is struck with the projectile; and wherein the method further comprises expanding the size of the second mine from the initial size upon being hit with a projectile.

3. The method as recited in claim 1 wherein said second mine has an initial maximum size; and wherein the method further comprises hitting the second mine with the projectile, and launching a second projectile from the second mine upon being hit with the projectile.

4. The method as recited in claim 1 further comprising shooting a projectile with the first mine at a second vessel on the grid in response to the first mine being selected.

5. The method as recited in claim 4, wherein said second vessel is removed from the grid upon being shot with the projectile.

6. The method as recited in claim 5 further comprising placing a reward container at the location on the grid of the second vessel when the second vessel is removed.

7. The method as recited in claim 6 further comprising selecting the reward container, displaying a reward in the container, and removing the reward container upon selection.

8. The method as recited in claim 7 wherein the displayed reward indicates a token that when selected moves a mine or a vessel; and wherein the method further comprises selecting the token and the mine or the vessel, and moving the mine or the vessel on the grid.

9. The method as recited in claim 1 wherein said second mine is disposed on the grid in the first row adjacent the first mine, has a first size and expands from the first size to a maximum size, and wherein the method further comprises:
expanding the size of the second mine from the first size to the maximum size upon being hit with a projectile;
hitting the second mine at the first size with a projectile originating from a third mine;
hitting the second mine at the maximum size with a second projectile;
launching a second projectile from the second mine and removing the second mine from the grid upon being hit with the second projectile; and
moving the first vessel in the first row over the former location of the second removed mine.

10. The method as recited in claim 1 further comprising: shooting a projectile with the first vessel at a second vessel or second mine on the grid in response to the first vessel being selected.

11. A computer readable medium having instructions for playing a video game with a display device, said instructions when executed by one or more processors comprise:
displaying, in a first row on a grid on the display device, a vessel at a first position adjacent a first mine at a second position;
receiving an indication from a game player input device to select the first mine;
in response to the first mine being selected, displaying an indication of a launching of a projectile from the first mine at a second mine and removing the first mine from the display; and
in response to the first mine being removed, indicating a change in position of the first vessel from the first position to the second position.

12. The computer readable medium as recited in claim 11, wherein said instructions further comprise indicting a hit on the second mine of the launched projectile by increasing the size of the second mine on the grid.

13. The computer readable medium as recited in claim 12, wherein said instructions further comprise:
indicating the position the second mine on the grid in the first row at a third position;
indicating a selection of the increased size second mine;
indicating removal of the second mine when selected;
in response to an indication of the second mine being removed, indicating a change in position of the first vessel from the second position across the third position and off of the grid.

14. The computer readable medium as recited in claim 11, wherein said instructions further comprise:
displaying, in a second row on the grid, a second vessel type at a third position in the same column as the first mine at the second position;
in response to the first mine being selected, displaying an indication of a launching of a projectile from the first mine to hit the second vessel; and
in response to the second vessel being hit, animating the second vessel.

15. A method for playing an electronic video game using a display device, the method comprising:
displaying, in a plurality of rows on a grid on the display device, a plurality of vessels, each vessel being disposed at a first position adjacent a first mine or a second vessel, the first position being in the same row as the first mine or the other vessel;
receiving an indication from a game player input device to select a second mine disposed on the grid;
in response to receiving the indication, displaying a launch indication of a launching of a projectile from the second mine toward the first mine;
removing the first mine from the display upon being hit with the projectile; and
in response to the first mine being removed, indicating a change in position of one of the vessels from the first position to the another position, wherein a path of said one of the vessels when changing position crosses the former location of the first mine.

16. The method as recited in claim 15 further comprising displaying a launch indication of said second mine launching multiple projectiles in only two different directions upon said second mine being selected.

17. The method as recited in claim 15 further comprising launching multiple projectiles in at least four different directions upon said second mine being selected.

18. The method as recited in claim 15 wherein said first vessel is of a type impervious to being struck by projectiles and the second vessel of a type that is destroyed by being struck with a projectile.

19. The method as recited in claim 15 further comprising shooting a projectile from the second mine toward another vessel.

20. The method as recited in claim 15 further comprising launching the projectile in a horizontal or a vertical direction from the first mine upon being the first mine being hit with the projectile.
